(19) United States
(12) Patent Application Publication
(10) Pub. No.: US 2026/0340385 A1
(43) Pub. Date: Oct. 29, 2026

(54) NEURAL NETWORK AUDIT ENGINE

(71) Applicants: Baylor College of Medicine, Houston, TX (US); William Marsh Rice University, Houston, TX (US)

(72) Inventors: Ankit Patel, Houston, TX (US); Ryan Pyle, Houston, TX (US); Yilong Ju, Houston, TX (US)

(73) Assignees: Baylor College of Medicine, Houston, TX (US); William Marsh Rice University, Houston, TX (US)

(21) Appl. No.: 19/702,819

(22) Filed: Jun. 9, 2026

Related U.S. Application Data
(63) Continuation of application No. PCT/US2024/057547, filed on Nov. 26, 2024.
(60) Provisional application No. 63/609,240, filed on Dec. 12, 2023.

(51) Int. Cl. G06N 3/08

(52) U.S. Cl. CPC G06N 3/08

(57) ABSTRACT

A method for auditing neural network performance may include receiving a first set of input data for the neural network and training the neural network. The method may further include updating an audit model of the neural network based on the training of the neural network and inputting, to the neural network the first set of input data. A first set of output data associated with the first set of input data may be received from the neural network, and an indication of one or more characteristics of the neural network that impacted the first set of output data may be generated based on the updated audit model of the neural network, the first set of input data, and the first set of output data.

### CROSS-REFERENCE TO RELATED APPLICATIONS

This application is a continuation of International Application No. PCT/US2024/057547 filed Nov. 26, 2024, under 35 U.S.C. § 111(a), which claims priority to U.S. Provisional Application No. 63/609,240 filed Dec. 12, 2023, both of which are incorporated herein by reference in their entirety.

### GOVERNMENT SUPPORT CLAUSE

This invention was made with Government support under 1707400 awarded by the National Science Foundation, ES027725 awarded by the National Institutes of Health, contract number D16PC00003 by the Intelligence Advanced Research Projects Activity (IARPA) via Department of Interior/Interior Business Center (Do I/I BC), and N00014-21-1-2908 awarded by the Office of Naval Research/Department of Defense. The Government has certain rights in the invention. The government has certain rights in the invention.

### FIELD OF THE DISCLOSURE

The instant disclosure relates to neural networks. More specifically, certain portions of this disclosure relate to auditing of trained neural networks.

### BACKGROUND

Neural networks, machine learning models, deep learning systems, and other artificial intelligence (AI) tools are increasingly being deployed in a variety of contexts. For example, neural networks may be used in a healthcare context, to analyze health data and recommend treatments, in a banking context, to analyze financial data for generating investment signals and/or loan recommendations, and in many other contexts. Neural networks may be deployed in a wide variety of scenarios to analyze large arrays of data.

The ways in which a particular neural network analyzes data may change and evolve over time through training processes, where training data, such as example input data and output data, may be supplied to the neural network to train the neural network to better analyze and/or make recommendations based on input data. Neural networks may start out complex with many factors being weighed based on proprietary algorithms in analyzing data and may become increasingly complex as they are trained and refined. As one example, complexity of neural networks may be increased in an attempt to enhance the accuracy of outputs of the neural networks. Neural networks may take millions of data points of a training data set as an input and may correlate specific data features to produce outputs. Such a process may be largely self-directed by the neural network, with little or no intervention by designers in the operation of the neural network after training begins. Furthermore, such models may operate as black box models, where input data is received and one or more outputs are provided, with little or no indication of how the output data was generated based on the input data and/or the factors that influenced the generation of the output data. Black box operation of neural networks may allow creators to protect their neural network algorithms and/or intellectual property behind the neural network algorithms from copying.

Shortcomings mentioned here are only representative and are included simply to highlight that a need exists for improved enhanced activity monitoring and reminder systems. Embodiments described herein address certain shortcomings, but not necessarily each and every shortcoming. Furthermore, embodiments described herein may present other benefits than, and be used in other applications than, those of the shortcomings described above.

### SUMMARY

A neural network audit engine may provide information indicating how outputs were generated by a neural network based on input data. For example, a neural network audit engine may indicate how neural network components, training data, and other factors, influenced an output generated by a neural network based on input data. Thus, a neural network audit engine may allow a user to look inside a black box of a neural network algorithm and determine characteristics of a neural network that influenced the output generated by the neural network. In particular, a neural network audit engine may monitor a neural network as the neural network is trained, such as through monitoring training data input to the neural network and outputs of the neural network in response to the training data, in order to generate and maintain an up-to-date model of the neural network. The up-to-date model of the neural network may be referred to as an audit trail or an audit tensor. As one particular example, the up-to-date model of the neural network may be a PNTK of the neural network as the PNTK is updated over time, and the PNTK, accounting for time-based evolution of the PNTK, may be an audit trail or an audit tensor. That is, the audit model of the neural network described herein, generated by the audit engine, may be distinct from a neural network model received by the audit engine and on which the audit engine performs the audit. A set of output data may be generated based on a set of input data, such as an audit set. The set of output data may, for example, include one or more outputs of the neural network generated based on a set of input data provided to the audit engine for analysis. Then, the audit engine may, based on the audit model, the training data, a set of input data, and a set of output data generated by the neural network based on the input data, indicate one or more characteristics of the neural network that impacted the set of output data. Thus, the audit engine may maintain an updated audit model of the neural network to allow the audit engine to, in response to input data provided to a neural network and output data provided by the neural network based on the input data, provide information regarding one or more characteristics of the neural network that caused the neural network to generate the output data based on the input data.

A neural network audit engine may operate by receiving training data, such as sample data and class/target information for the sample data and desired features that will be grouped for further analysis. The neural network audit engine may further receive one or more relevant test cases, such as one or more sets of input data for the neural network, for analysis by the audit engine. The audit engine may monitor training of the neural network, recording, tracking, and analyzing relevant values output by the neural network based on gradients from the training process. Such monitoring may include updating an audit model of the neural network maintained by the audit engine based on the training. The audit engine may generate using the trained neural network one or more outputs of the neural network corresponding to the one or more test cases. For example, the audit engine may input the test cases to the trained neural network and may receive outputs from the trained neural network based on the input test cases. The audit engine may then generate one or more indications of characteristics of the neural network that impacted the outputs of the neural network based on the input data. Such indications may further be used to perform secondary analysis on the audit engine outputs to provide recommendations for enhancing training data sets and/or neural network performance.

Insight into the internal operation of a neural network, such as provided by the audit engine discussed herein, may provide enhanced transparency and explainability for the neural network. For example, in highly regulated markets, such as healthcare markets, financial markets, and other markets where computer or machine-generated decisions can result in regulatory violations, death or injury, or financial loss, insight into internal characteristics of a neural network may be imperative. Furthermore, such insight may allow for enhancement of accuracy and operation of neural networks, enhancement of neural network training data sets, and debugging of neural network models, audit models, and training data sets. For example, if a neural network contains errors following training that lead to producing incorrect outputs, debugging and enhancement of neural networks following training may be costly and difficult or even impossible. The transparency and visibility into the operation of neural networks provided by a neural network audit engine may enhance support for environmental, social, and governance (ESG) goals in the context of AI. For example, an audit engine may allow for detection and correction of AI bias that may result from algorithms implementing conscious or unconscious prejudices of developers, which may result in undetected errors. That is, a biased neural network algorithm may produce skewed outputs that could be offensive or harmful to people affected. Such bias may result from bias in a training data set, such as when bias inherent in a training data set is unnoticed, or from bias inherent in other characteristics of the neural network. Bias may be detected, mitigated, and/or eliminated through use of a neural network audit engine to detect biased characteristics of a neural network for correction. Errors in neural network operation, such as those resulting from bias, that are allowed to persist may result in reputational and/or legal damage to an organization operating the neural network, but use of a neural network audit engine may allow organizations to detect and correct errors in internal neural network operation. Use of a neural network audit engine may provide insight into the internal characteristics of a neural network without requiring simplification of the neural network and/or reduced accuracy of the neural network that may arise from such simplification. Furthermore, a neural network audit engine may be applied in a variety of contexts, allowing for auditing of neural networks of many varieties using the audit engine with minimal adjustments to operation of the audit engine. For example, an audit engine as described herein may be applied in a general machine learning context, a computer vision context, such as with respect to neural network models for medical imaging and/or analysis, optical character recognition, and video tracking, a drug discovery and development context, such as with respect to toxicogenomics or quantitative structure-activity relationship analysis, a geostatics context, a speech recognition context, a handwriting recognition context, a biometric identification context, a biological classification context, a statistical natural language processing context, a document classification context, an internet search engine context, a credit scoring context, a pattern recognition context, a recommender system context, a microarray classification context, and other contexts.

A method for auditing neural network performance may include receiving a first set of input data for the neural network, training the neural network, updating an audit model of the neural network based on the training of the neural network, inputting to the neural network the first set of input data, receiving from the neural network a first set of output data associated with the first set of input data, and generating, based on the updated audit model of the neural network, the first set of input data, and the first set of output data, an indication of one or more characteristics of the neural network that impacted the first set of output data. As one particular example, an audit engine may perform the operations described herein. For example, an audit engine executed by a computing system may perform the operations described herein.

An apparatus may include one or more memories storing processor-readable code and one or more processors coupled to the one or more memories, the one or more processors configured to execute the processor-readable code to cause the one or more processors to perform operations including receiving a first set of input data for the neural network, training the neural network, updating an audit model of the neural network based on the training of the neural network, inputting to the neural network the first set of input data, receiving from the neural network a first set of output data associated with the first set of input data, and generating, based on the updated audit model of the neural network, the first set of input data, and the first set of output data, an indication of one or more characteristics of the neural network that impacted the first set of output data.

A computer program product may include a non-transitory computer readable medium comprising instructions for causing one or more processors to perform operations including receiving a first set of input data for the neural network, training the neural network, updating an audit model of the neural network based on the training of the neural network, inputting to the neural network the first set of input data, receiving from the neural network a first set of output data associated with the first set of input data, and generating, based on the updated audit model of the neural network, the first set of input data, and the first set of output data, an indication of one or more characteristics of the neural network that impacted the first set of output data.

An apparatus may include means for receiving a first set of input data for the neural network, means for training the neural network, means for updating an audit model of the neural network based on the training of the neural network, means for inputting to the neural network the first set of input data, means for receiving from the neural network a first set of output data associated with the first set of input data, and means for generating, based on the updated audit model of the neural network, the first set of input data, and the first set of output data, an indication of one or more characteristics of the neural network that impacted the first set of output data.

The steps described herein may be included in instructions of a non-transitory computer readable medium of a computer program product for execution by a computing device, such as a processor, to carry out certain steps of the disclosure. For example, a processing station may execute a computer program to perform steps of receiving and determining, as disclosed herein. Furthermore, an apparatus, such as a computing system as described herein, may include a memory and a processor for performing the steps described herein.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram of a black box neural network according to one or more aspects of the disclosure.

FIG. 2 is a block diagram of a server and a client device according to one or more aspects of the disclosure.

FIG. 3 is a block diagram of an audit engine in communication with a client device, according to one or more aspects of the disclosure.

FIG. 4 is a set of graphs showing generation of a neural tangent kernel (NTK) matrix according to one or more aspects of the disclosure.

FIG. 5 is a block diagram of a neural network audit model according to one or more aspects of the disclosure.

FIG. 6 is a flow chart of an example method for performing a neural network audit according to one or more aspects of the disclosure.

FIG. 7 is a flow chart of an example method for adjusting a neural network and/or one or more data sets according to one or more aspects of the disclosure.

FIG. 8 is a block diagram of an example computing system, according to one or more aspects of the disclosure.

### DETAILED DESCRIPTION

A neural network audit engine may be used to analyze training and operation of a neural network to provide information regarding the internal operation of the neural network, such as content or time-related aspects of training and/or internal functions of the neural network that impacted a particular output of the neural network based on a particular input. For example, the neural network audit engine may allow a user to break down and understand how and why a neural network has produced a particular output based on a particular input. Such analysis may allow users to attribute a decision to various architectural and training components of the neural network, allowing for enhanced understanding of the neural network and the ability to fix errors or biases in neural network functions and/or training data. The neural network audit engine may generate such information by monitoring training of a neural network, such as by updating an audit model of a neural network based on training of a neural network. For example, a neural network audit engine may receive training data for a neural network and input data for a neural network, such as one or more sets of data for which a user wishes to know outputs of the neural network and characteristics of the neural network that impacted the outputs of the neural network. The neural network audit engine may generate indications of characteristics of the neural network that impacted output data associated with the input data based on the training data, the input data, the output data, and the updated audit model of the neural network.

As one example, the audit engine may apply neural tangent kernel (NTK) theory to evaluate and probe influence functions of the neural network over time as the neural network is trained. For example, the audit engine may perform such analysis across multiple contexts, to determine how outputs of the neural network relate to past training data used to train the neural network, over training time, to determine how temporal dynamics of training of the neural network impacted outputs of the neural network, and over architectural components of the neural network, to determine how outputs of the neural network are impacted by parameters or parameter groups corresponding to architectural components of the neural network. The audit engine may be flexible, able to audit any neural network architecture that is updated via gradient descent, and thus all deep learning neural networks and a wide array of other machine learning techniques and algorithms.

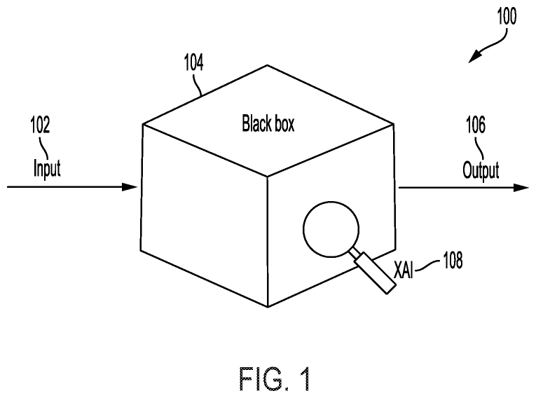

A block diagram 100 of an example neural network is shown in FIG. 1. As shown in FIG. 1, neural networks may operate as black box systems, receiving inputs 102, in the form of training or other input data sets, and providing outputs 106, in the form of recommendations or other data based on processing of the input data according to functions of the neural network 104. The neural network 104 may be a complex system for providing accurate outputs 106 based on inputs 104, and little visibility into the operation of the neural network 104 may be provided. Furthermore, the internal working of neural network 104 may change over time as the functions of the neural network 104 are adjusted based on inputs 102. Explainable artificial intelligence techniques, such as the neural network audit engine described herein, may provide insight into the internal operation of the black box neural network 104, such as through indication of characteristics of the neural network 104 that caused particular outputs 106 to be generated in response to particular inputs 102.

As one particular example, an audit engine may utilize an NTK framework to provide information regarding operation of neural networks through use of kernel-based understanding of neural networks, providing the ability to break down how particular neural networks understand, group, and generalize based on training inputs. The NTK is a kernel that describes neural networks. The NTK may be random at initialization and may vary during training, except in the infinite-width limit, where a neural network converges to the kernel regime and the NTK becomes constant. Using gradient descent on a neural network with learning rate n and parameters θ,

$$θ ( t + 1 ) = θ ( t ) - η \frac{dL ( θ )}{d θ} \qquad Equation 1$$

with gradient flow providing:

$$\dot{θ} = - \frac{dL ( θ )}{d θ} . \qquad Equation 2$$

Assuming loss depends only on the network output ŷ, this equation can be rewritten as:

$$\dot{θ} = - \frac{dL}{d \hat{y}} \frac{d \hat{y}}{d θ} \qquad Equation 3$$

This function may change in accordance with Equation 4

$$\dot{\hat{y}} ( θ ) = \frac{d {\hat{y} ( θ )}^{T}}{d θ} \dot{θ} = - \frac{d {\hat{y} ( θ )}^{T}}{d θ} \frac{dL θ}{d \hat{y}} \frac{d \hat{y} θ}{d θ} \qquad Equation 4$$

where the

$$\frac{d {\hat{y} ( θ )}^{T}}{d θ} \frac{d \hat{y} ( θ )}{d θ}$$

is known as the NTK.

$${K}^{′} = - \frac{d {\hat{y} ( θ )}^{T}}{d θ} \frac{d \hat{y} ( θ )}{d θ} \qquad Equation 5$$

If the model is close to linear, e.g. in its kernel regime, then the NTK will not change over training, allowing the entire θ update function to be very interpretable.

If the model is not close to linear, the NTK may be more properly characterized as NTK(t), e.g. time dependent. In this case, tracking the overall changes to the model ŷ may require taking out of the path of the NTK over time, or the Path NTK (PNTK, P′). For example, let the NTK(t) be given by K′(t), and the PNTK by P′. All kernel machines that follow gradient descent may provide a path kernel:

$${P}^{′} ( x , {x}^{′} ) = {\int }_{θ ( t )} \frac{d \hat{y} ( x , t )}{d θ} \cdot \frac{d \hat{y} ( {x}^{′} , t )}{d θ} d t \qquad Equation 6$$

resulting in a kernel machine with a model of the form

ŷ(x)=g(Σi∈N P(x,xᵢ)+b) Equation 7

for nonlinearity g and initialization b (i.e. b=ŷ(t=0)). In some aspects, g=I. However, if specific probabilities of a classification problem are computed, then g would be a softmax function, and ŷ=p(y) would be the probabilities rather than raw logit scores. For using a neural network with a loss function L whose derivative with respect to ŷ is L′,

ŷ(x,t)=ŷ(x,t=0)−∫_{θ(t)}ΣₙL′(yₙ,ŷₙ)K′(x,xₙ)dt Equation 8

e.g. the path kernel is the path integrated NTK, weighted by the loss function along the path.

Use of the base NTK of Equation 9

$${K}^{′} ( x , {x}_{n} ) = \frac{d {\hat{y} ( θ , x )}^{T}}{d θ} \frac{d \hat{y} ( θ , {x}_{n} )}{d θ} \qquad Equation 9$$

may be less useful in practice for computing a PNTK. For example integration over the NTK weighted by its loss sensitivity may provide an enhanced description of the NTK, as follows

$$K ( x , {x}_{n} ) = \frac{d L}{d {y}_{n}} {{K}^{′}}^{( x , {x}_{n} )} = \frac{d L}{d {y}_{n}} \frac{d {\hat{y} ( θ , x )}^{T}}{d θ} \frac{d \hat{y} ( θ , {x}_{n} )}{d θ} . \qquad Equation 10$$

Thus, the PNTK, P, and complete PNTK, P′, may be time integrals of their respective NTKs:

$${P}^{′} ( x , {x}_{n} ) = {\int }_{{θ}_{t}} {K}^{′} ( x , {x}_{n} ) = {\int }_{{θ}_{t}} \frac{d {\hat{y} ( θ , x )}^{T}}{d θ} \frac{d \hat{y} ( θ , {x}_{n} )}{d θ} \qquad Equation 11$$

$$P ( x , {x}_{n} ) = {\int }_{{θ}_{t}} K ( x , {x}_{n} ) = {\int }_{{θ}_{t}} \frac{d L}{d {y}_{n}} {K}^{′} ( x , {x}_{n} ) = {\int }_{{θ}_{t}} \frac{d L}{d {y}_{n}} \frac{d {\hat{y} ( θ , x )}^{T}}{d θ} \frac{d \hat{y} ( θ , {x}_{n} )}{d θ} . \qquad Equation 12$$

In practice, the complete PNTK P, may be useful, as

ŷ(t)=ŷ₀+ΣₙP(x,xₙ). Equation 13

Thus, the PNTK as described herein may provide an audit model of a neural network that can be used by an audit engine to provide indications of characteristics of the neural network that caused the neural network to generate particular outputs based on particular inputs.

As one particular example, a simple PNTK, based on regression on a simple, shallow or few-layer feed-forward rectified linear unit (ReLU) neural network, with one output dimension and a maximum likelihood implementation loss function may be used. A training set x_{N} and testing set x_{M} which may correspond to training data and input data, or audit data, as discussed herein may be received. An audit model initialization y₀=model (x_{M}) of the neural network may be stored, and the PNTK may be set to P=zeros(N,M). For each epoch, or training time period, y_{N}=model(x_{N}) and y_{M}=model(x_{M}) may be computed. A NTKtrain parameter may be set to zeros (N, numparams) and an NTKtest parameter may be set to =zeros (M, numparams) For n in N, gradients

$$\frac{d {y}_{N} ( n )}{d θ}$$

may be stored in NTKtrain[n,;], and for m in M, gradients

$$\frac{d {y}_{M} ( m )}{d θ}$$

may be stored in NTKtest[m,:]. The audit model may then be updated, such as using an optimizer.step function, and P[n,m] may be updated to equal (NTKtrain[n,:], NTKtest[m,:]) 2η((ŷ)ₙ−yₙ). If n is small, then ΣₙP (n,m)+y₀ will closely match ŷ_{M·} aafter training.

Use of such a basic implementation may encounter a number of issues. One issue may include maintaining both a learning rate η small enough that the PNTK is accurate, while the number of epochs, or time periods, is large enough that the neural network is trained sufficiently to be useful. It may be possible for a combination of (η, epochs) to successfully train a model, while a PNTK, or audit model, generated while monitoring the training of the model is not accurate to the model. This may result from the PNTK working as a linear interpolation of the true underlying gradient flow. Thus, the PNTK may be particularly inaccurate at regions where linear forecasting fails to capture the ground truth. One example of this is predicting, with precision, data points, such as for ReLU activations, where a loss surface at a data point can form a non-continuous sharp minima, with the model parameters vibrating around the minima, driving up error.

Training the PNTK may also require substantial time, even per-epoch, which may be further exacerbated by an increased number of epochs needed to accommodate a lowered n needed to successfully obtain an accurate PNTK. For example, generating the PNTK may require calculating all of the gradients for each set of training data and input data individually in order to populate NTKtrain and NTKtest.

Use of a PNTK as an audit model of a neural network may be particularly useful in the context of classification tasks, but may run into problems when performing regression operations. For example in the context of a regression, a loss function may change according to

$$\frac{d L}{d y}$$

and multiple outputs may be received from a neural network. For example, a final PNTK for regression operations may be a function P[n, m, c] for training input n, testing input m, and output class c. Similarly, an NTKtest parameter may also be expanded with an extra dimension of size C. When computing NTKtest, an additional for loop over c may be added.

In some aspects, a PNTK may be calculated by taking the dot product over the parameter dimension of NTKtrain and NTKtest. However, an extra dimension r may be added to the NTK, with P[n,m,c,r] updated according to NTKtrain[n,r]·NTKtest[m,c,r]. Such an operation may run into memory limitations, as r may be the largest dimension. An alternative approach may be to collapse the PNTK over n instead of r, losing per-training example information, but allowing examination of the effects of various layers or filters in the neural network to look for patterns of interest. Such an operation may be significantly faster-generally, N>>M, and collapsing over n may allow for use of just the per-batch gradients, without breaking the gradients up by n (e.g. collapse over n in the NTKtrain), saving substantial computation time. Additionally, instead of than having a dimensionality of r as the number of parameters, r may be collapsed over parameter groups of interest, e.g. one per layer.

Similarly, a base PNTK may implicitly collapse over a time dimension by Path-integrating (in practice, summing) over the individual NTKs at each iteration. Such an operation may be expanded, providing an NTK of dimensionality N[t,n,m] (or even N[t,n,m,c,r]). In practice, expanding over t may involve collapse over other dimensions to maintain reasonable memory requirements. Expanding over t may allow tracking of how the neural network's dynamics evolve over time, such as through rounds of training. Such analysis may be relevant for analyzing switching modes of learning, sudden capacity or performance changes, and other changes in neural network operation over time. For example, in some linear systems linear transformations may be captured one eigenvector at a time, with a rate proportional to the eigenvalue. Accordingly, breaking down the NTK over time would allow for understanding each eigenvector learned individually. Non-linear systems may also undergo different phases of learning that would be amenable to a similar analysis.

As discussed herein, efficiency and utility of the PNTK may be enhanced by partially collapsing over dimensions in such a way that the most salient information is still available. Although particular examples of specific dimensions are discussed, cross-dimensional analyses may also be possible. Such dimensions may, for example, correspond to particular categories of characteristics of a neural network, such as training data, architecture, features of the neural network over time, and other characteristics.

For example, training and/or testing data, such as training data used to train a neural network, may be collated by features of interest in order to make human-interpretable analysis easier. As one particular example, such data may be grouped by class—allowing the PNTK analysis to determine what affect training on class cᵢ has on class cⱼ. Other potential example groupings may include: grouping together outliers, grouping examples by their difficulty to learn, or grouping by presence/absence of human defined features (e.g. for MNIST, grouping 1s with a bottom horizontal stroke vs those without). These features of interest may require manual identification on a per task basis. One important analysis such collating enables is data pruning, by allowing the PNTK to analyze the relative effects of removing the least important data, potentially allowing for faster training and inference.

As another example, architecture, such as architectural components of a neural network, may be collated over areas of interest. For example, architectural layers may be separated (allowing the PNTK to compare the value of different layers to a learning process). However, such analysis may also be performed comparing standard and skip connections, or between any other groups of transformations used by the neural network. Such analysis may be used to efficiently allocate (or re-allocate) parameter counts to various layers or features, potentially improving neural network performance and/or speed.

As another example, neural networks may undergo phase transitions, where a behavior changes or a new skill of the neural network is acquired over time. The PNTK's time analysis may be collapsed into a pre- and post-group for each phase transition, allowing for analysis of multiple phases of learning or training. Alternatively, the transitions may be sampled uniformly or randomly, allowing for an analysis of the relative importance of the various training segments. Such analysis may be used to more efficiently allocate training time by reducing time spent in low-value terminal time segments.

A final (base) PNTK may have a shape [N,M,C] (note this can apply to univariate-just take C=1), such that P[n, m, c] describes the logit contribution of testing example xₘ corresponding to class/output c that comes from training example xₙ. Summing over n may thus recover the true logits, or ŷ(xₘ) (minus the initial condition ŷ(xₘ,t=0)). Such analysis can be broken down to allow for determination of what the neural network has learned and how it makes decisions. For example, summing over m contingent on correctness may allow a user to determine the ‘value-add’ for an individual data point xₙ. Summing over m without any contingency on c may allow a user to determine the overall effect of datapoint xₙ on logit outputs. Sorting by n may allow a user to see which training data is maximally influential. Sorting by n only over wrong or incorrect examples of m may allow a user to determine training examples that maximally contributed to the error, allowing for discovering label errors and/or finding a incorrectly learned feature. Grouping by c allows for checking of easily-confused classes, or other significant cross-class effects. If additional features of the input or output are known besides class membership, such as specific features, such features can be sorted to determine their effect. Although some metrics may be dataset or task-reliant, others may be used to analyze a wide array of neural networks.

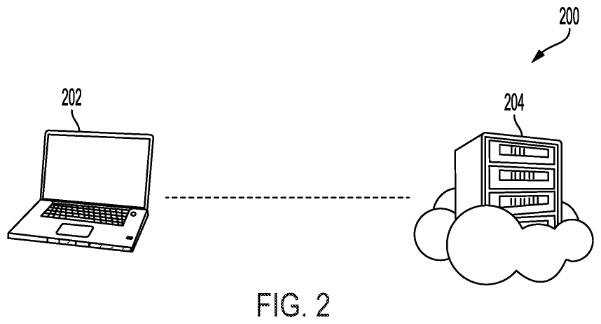

A neural network audit engine may be executed on a server, or other computing system, analyzing a neural network based on information received from a client device. FIG. 2 is a block diagram 200 of a server 204 in communication with a client device 202. The client device 202 may, for example, be a laptop computer, a server, a desktop computer, a smart phone, or another computing device. The server 204 may receive information regarding a neural network such as one or more files of a neural network, from the client device 202, along with audit data and training data. The server 204 may execute an audit engine, training the neural network using the received training data to analyze performance of the neural network across one or more test cases of the audit data. The server 204 may generate one or more indications of characteristics of the neural network that impacted outputs generated by the neural network based on the audit data and may transmit such indications to the client device 202.

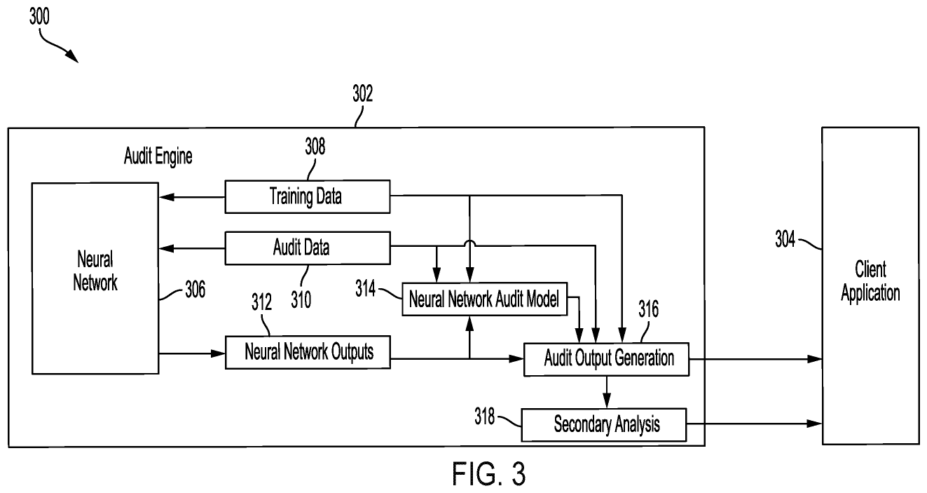

An example audit engine 302, which may be executed by a remote server, in communication with a client application 304, which may be executed by a client device, is shown in the block diagram 300 of FIG. 3. The audit engine 302 may receive a neural network 306, such as a program file or code for a neural network, from a client application 304, such as a client application executed by a client device. In some aspects, the audit engine 302 may not receive the neural network 306 and may monitor training and execution of the neural network 306 on another device, such as on a client device. The audit engine 302 may further receive training data 308 from the client application 304. Alternatively or additionally, the audit engine 302 may otherwise receive or generate training data 308. Training data 308 may, for example, be training data for training the neural network 306. The training data 308 may include one or more training data sets for use in training the neural network 306. For example, the training data 308 may include class and/or target information for multiple data samples. In some aspects, the training data 308 may include multiple sets of training data for multiple rounds of training of the neural network 306, such as for multiple epochs. The audit engine 302 may receive audit data 310 from the client application 304. Audit data 310 may include data for test cases for the neural network 306 to be applied by the audit engine 302 as the neural network 306 is trained to determine characteristics of the neural network 306 that impact output data, such as neural network outputs 312 generated based on the audit data 310. The audit data 310 may also be referred to herein as input data or test data. For example, the audit data 310 may include inputs for the neural network 306 based on which an audit is to be performed.

The audit engine 302 may train the neural network 306 using the training data 308 and may monitor training of the neural network 306, such as inputs and outputs of the neural network 306 as the neural network 306 is trained using the training data 308. For example, the audit engine 302 may generate and/or update a neural network audit model 314 based on monitoring the training of the neural network 306. The neural network audit model 314 may, for example, be a PNTK for the neural network 306, or a modified format of the PNTK. In some aspects, the audit engine 302 may update the neural network model audit model 314 multiple times during training of the neural network, such as between epochs of training of the neural network 306. In some aspects, the audit data 310 may be the training data 308 or may partially overlap with the training data 308. In some aspects, the audit engine 302 may provide the audit data 310 as input data to the neural network 306 one or more times during training of the neural network 306, and the neural network 306 may generate neural network outputs 312 based on the audit data.

An audit output generation module 316 may generate audit engine outputs based on the training data 308, the audit data 310, the updated neural network audit model 314, and/or the neural network outputs 312. The audit outputs may, for example, include indications of one or more characteristics of the neural network 306 that impacted generation of the neural network outputs 312 based on the audit data 310, such as indications of one or more temporal aspects of the neural network, one or more architectural components of the neural network, and one or more training characteristics of the neural network.

As one particular neural network characteristics example, one or more influence parameters associated with one or more components of the training data 308 may be generated by the audit output generation module 316. For example, one useful metric derived from the PNTK, which may be a characteristic of a neural network as discussed herein, is an associated ‘influence-scaling’, which measures an effective ‘weight’ of each sample within a training data set used to train the neural network and generate the PNTK. Such influence factors may be used to find clusters or outliers, as well as generally give more intuition into what training examples may cause problems. In a kernel, influence weights may be related to the per-example weight a. For example, the audit engine may analyze

$$\frac{d L}{d {y}_{c} ( {x}_{n} )} ,$$

or the influence of each particular output from each training point on the overall loss of the neural network. An influence weight may be a key metric found in the original single time step NTK update, which actually is a kernel using that kernel weight. Summing such a factor up over time may provide an R^{N} by R^{c} matrix which may describe the overall influence each output has had throughout training:

$$Influence [ n , c ] = {\sum }_{t} \frac{d L}{d {y}_{c} ( {x}_{n} )} ( t ) \qquad Equation 13$$

Influence calculation may be used to recreate the qualitative findings of the NTK kernel, with the added advantage of being meaningful for PNTK and multi-output settings as well.

As another neural network characteristics example, one or more characteristics of the neural network generated by the audit output generation module 316 may include one or more raw PNTK characteristics of the neural network. As another example, a raw PNTK may be or indicate one or more characteristics of a neural network. A PNTK used to predict ym cannot be put into kernel form. However, useful kernel-based analysis and mathematical frameworks may be lost by using a pseudo-kernel instead of a kernel. The kernel form (distinct from the PNTK form) of the neural network may be considered, where the loss sensitivity is dropped for analytical purposes, to generate a raw kernel. The raw kernel may be given by the raw PNTK or raw NTK:

$$R N [ n , m ] = \frac{d {\hat{y}}_{n}}{d θ} \frac{d {\hat{y}}_{m}}{d θ} \qquad Equation 14$$

RP[n,m]=sum(RN[n,m](t). Equation 15

The raw PNTK may provide a similarity between xₙ, xₘ while ignoring the effects of the loss function. Because the loss function has a large impact on the effective gradients and subsequent audit model updates, the raw PNTK may be less useful for predicting actual network performance. However, the Raw PNTK may be useful for breaking down internal model similarity functions, particularly when used in conjunction with the eigen-decomposition and/or singular value decomposition (SVD) analysis techniques.

For example, a PNTK matrix may be decomposed using standard matrix analysis techniques. For example eigen-decomposition, possible in the case that M=N, achievable by setting x_{M}=xₙ, such as by setting the testing set, or input data as described herein, equal to the training set, or training data as described herein, may be used to decompose the PNTK matrix. Such a technique may be useful for determining the most important modes (eigenfunctions) for building a the similarity matrix. In simplified settings, such decomposition may provide a complete understanding of how a network learns to build a decision boundary from a set of fixed basis functions. More generally, the eigenvalues may be used to determine how ‘complex’ the similarities are with a quickly decaying eigen-spectra denoting a ‘simpler’ understanding, which may mean that either a task is simpler or that the model is especially well suited to the task. As another example, the SVD may be used in a more general case where M!=N. One difference from the eigen-decomposition case is that SVD includes a left and a right singular vector, as compared to the eigenvector. The left and right singular vectors correspond to the similarities over the testing set M and training set N, which are linked together. As in the eigen-decomposition example, the singular values may be useful for understanding the ‘complexity’ of the neural network's internal influence function.

As another example, dPNTK functions may be or may be used to determine characteristics of a neural network that impacted generation of one or more outputs based on the PNTK. For example, dPNTK methods may examine how changes to x_{N} or x_{M} change a PNTK, effectively demonstrating how either the training data or the testing data, such as the input data, may be modified to enhance neural network performance. Such analysis may also provide a breakdown per-training or testing example for more granular analysis. As one example, dPNTK methods may allow for consideration of how to change testing data x_{M} such that the overall accuracy of the neural network is increased. Such a determination may be made through examination of the PNTK, specifically by calculating

$$\frac{dP}{d ( {x}_{M} )} .$$

For example, the PNTK is a matrix of size [N, M, C], while x_{M} is of size [M, D], where D is the input dimensionality. The output of such an operation may be a matrix dPₜₑₛₜ of size [N,M,C,D], where element dPₜₑₛₜ [n, m, c, d] describes a direction that input d of testing example m should be changed by in order to move the logit evidence due to training example n towards class c. Summing over n thus gives the direction that input d of testing example m should be changed by in order to promote class c activity. As another example, dPNTK function, the

$$\frac{dP}{d ( {x}_{M} )}$$

may be used to determine a change to the training data xx such that the overall accuracy of the with respect to the testing data is increased. Once again, we can use the PNTK, specifically by calculating

$$\frac{d P}{d ( {x}_{N} )} .$$

The final output may be a matrix dPₜᵣₐᵢₙ of size [N,M,C,D], where element dPₜᵣₐᵢₙ[n, m, c, d] describes the direction that input d of training example n should be changed by in order to move the logit evidence of testing example m towards class c. Summing over m conditioned on the true class c will show the overall direction that each xₙ should be changed by in order to maximize the true logit probabilities.

As another example, one or more characteristics of the neural network 306 generated by the audit output generation module 316 may include one or more impact parameters associated with one or more internal functions of the neural network 306. Impact may, for example, indicate an influence of each of multiple functions within a neural network in generating output data based on input data. The PNTK may have dimensionality [N,M,C], breaking down the logits for each output of each testing example based on each training example. Therefore, summing over N may recover the original logits, similar to a scenario where the testing set x_{M} is been run through the model (provided the PNTK approximation is sufficiently accurate). Instead of summing over N, slicing over N may be performed, such as to generate PNTK[n,M,C], which may provide the logit influence of training example n over all testing examples M and output dimensions C. One way to measure an importance of each training example, such as each item of training data, is to determine the magnitude of such slices, such as by taking the sum of their absolute values. Such sums may be referred to as an impact of each slice.

Impact[n]=ΣₘΣ_{c}|P[n·m·c]| Equation 16

Other related metrics, may also be generated and/or considered. For example, refraining from summing over c may provide a per-class per-training influence parameter. Summing over m rather than n may provide a measure of how much influence each testing point receives. Receiving low influence may be indicative of a test point that is not well described by the training set. Thus, impact may be high for data points that are either near to or far from a class boundary. Impact may be lowered by having multiple other nearby data points. Retraining without low-impact points, such as with low impact points removed, may result in a very similar final fit (e.g. with similar final logits).

As another example, the one or more characteristics of the neural network 306 generated by the audit output generation module 316 may include one or more utility parameters for one or more classification tasks, such as to one or more items or sets of training data 308. Utility parameters may apply to classification tasks, such as to sets of training data used to train a neural network. Utility may be related to influence, but may take advantage of knowledge of a correct class (for training data) to inform the audit engine of whether the influence is helpful (towards the correct class) or not.

Utility[n]=Σₘ(P[n,m,c=cₘ]−Σ_{c≠c}_{ₘ}P[n,m,c′]) Equation 17

where cₘ is the true class of training example m. Pruning a training data set by utility may maintain training examples that provide evidence towards correct classes, while removing those that provide evidence towards incorrect classes. As another example utility may be calculated without summing over m, providing a separate utility value for each train-test pair, such as for each pair of training data and audit data. Thus, a utility value may be highest for training points that are far away from a class boundary, low for intermediate points, and strongly negative for points near a class boundary and strongly negative for mislabeled points. Removing low-utility points from a training data set may result in little or no change to a resulting PNTK, but removing points near the class boundary may reduce near-boundary accuracy.

Several variants of utility parameters may also be included as neural network characteristics. For example, scaled utility may scale up an amount that a positive contribution (towards correct class) is weighted by a factor of C−1. Such scaling may ensure that a constant logit increase to all classes will have a scaled utility of 0, just as it will have no effect on the overall PNTK audit model's predictions. Alternatively, providing negative evidence to all classes makes standard utility positive, even if additional evidence is provided against the true class.

Utility−Scaled[n]=Σₘ((C−1)P[c,m,c=cₘ]−Σ_{c≠c}_{ₘ}P[n,m,c]) Equation 18

As another example, targeted utility may examine utility only along a single output dimension. For example, in some scenarios every output class may not be of interest, such as when a wrong class evidence is very negative and a small positive error is of little impact or when for a wrong class evidence is only slightly negative compared to the true class. Targeted utility may allow for direct comparison of evidence provided for the correct class against evidence provided for a specific other class, such as a mistaken class.

Utility−Scaled[n]=Σₘ<(P[c,m,c=cₘ]−P[c,m,c=c*]> Equation 19

for a specific target c*. The summation over m may, in some cases, be dropped, as c* may be a function of m.

As another example, the one or more characteristics of the neural network 306 generated by the audit output generation module 316 may include one or more difficulty parameters for one or more classification tasks, such as to one or more items or sets of training data 308. Difficulty may indicate the amount of learning (e.g. effort or difficulty) over the target component required during the training process. Difficulty may be independent of an audit set, such as an input data set, and may be purely a function of training the neural network. The difficulty of a single update for a specific n,c,t,a is given by

$$\vert \frac{d {\hat{y}}_{m} [ c ]}{d θ ( t ) [ a ]} \vert .$$

To obtain a per-component difficulty, other components may be summed over. For example, to generate per-training example difficulties, may be

$${\sum }_{t} \vert \frac{d {\hat{y}}_{m}}{d θ ( t )} \vert$$

may be determined, which may represent how much time and model learning is devoted to fitting each training point.

Thus, the audit output generation module 316 may assign attributions of neural networks' decisions to various components, such as by breaking them up per training datum, although per neural network component. The audit engine 302 may provide the user with a full accounting for where the evidence for any particular neural network decision comes from, broken down by influences coming from both training and various neural network sub-components. Such accounting may make the neural network more interpretable and may otherwise increase compliance with regulatory requirements that require an explanation of neural network decisions and outputs. For example, the audit engine 302 may closely audit a single output by a neural network, performing decision auditing to provide a fine-grained breakdown as to why a particular output was generated. For example, P[n,m=mᵢ,:,t,a] provides a complete understanding of how a training example, n, temporal component, t, and architectural component, a, contributed to the ith audit output mᵢ. Such variables can be summed over to remove them if not of use. For example, if only the training data effect is wanted, sum over t and a. As another example, such information may be analyzed to determine how training data with or without a certain feature contributed to the output, to understand the importance of that feature to output on mᵢ.

A secondary analysis module 318 may generate further indications of characteristic of the neural network, such as based on outputs of the audit output generation module 316. For example, the secondary analysis module 318 may provide error analysis data, allowing users to more precisely locate sources of errors in neural network outputs in order to resolve such errors. In particular, the audit engine 302 may, through the secondary analysis module 318, aid users in finding outliers in training data sets, or more subtly concerning training data, that are misleading the network. For more systematic errors, the secondary analysis module 318 may provide a proximal explanation relating error to the audit engine's internal distance metric over various training samples, leading to a set of misaligned features. Such error analysis may also be advantageous in the context of adversarial attacks, as an analysis of the decision may show misleading similarity patterns. As one particular example, the audit engine 302 may, through the secondary analysis module 318, be extended from analyzing individual decisions, as described above with respect to decision auditing, to analyzing entire classes of decisions. Such class-based analysis may allow for enhanced understanding of the causes of errors. For example, the audit engine may analyze slices using a combination of the following operations to generate a custom analysis of P[n, m, c]: group n to classes, group m to classes, group m to correct and incorrect decisions, or by magnitude of error, group m by correct answer and incorrect answer, slice c to the class of n, such as to understand output influence from matching training data, slice c to the class of m, such as to understand output influence from correct answers, group or sort n based on a specified feature, group or sort m based on a specified feature, and other operations. As one example, examining an incorrect m, slicing by correctness, grouping by incorrect answer and correct answer, and slicing c to the class of n may allow a user to determine how training data of class c₁ led to errors as the true solution was c₂, specifically focusing on incorrect evidence provided towards class c₁ (for all c₁ and c₂).

As another example of characteristics of the neural network 306, the secondary analysis module 318 may provide evidence into the mechanisms by which decisions are made by a neural network. For example, Normal A/B testing may allow for differentiating high-level results. However, access to the audit engine analysis of models A and B may allow for a view of how the neural network actually computed the resulting different answers. In particular, even models that obtain a same result on a point xₘ may do so differently. Thus, the difference between the audit engine analysis may provide an exact computational difference between two different neural network models.

As another example, the secondary analysis module 318 may generate a true, underlying similarity metric used by the neural network in order to make decisions, such as based on the PNTK. The PNTK may be used to understand the neural network's own internal distance metric between training and testing data, such as between training data and input data as discussed herein. Such understanding may facilitate determinations of how a neural network will cluster data, may facilitate detection of outliers, may facilitate reverse engineering of the features used by a trained neural network, and other analysis of a neural network. The dense information provided by the PNTK may facilitate a large variety of task-specific, user generated queries to allow a user to better understand the interaction between a training data set and a neural network. As another example, NTF vectors can be analyzed over a dataset or subset of a dataset in order to perform a low rank decomposition. Such analysis may be used to validate whether a neural network's grouping or understanding of the data follows known properties or to extract the neural network's grouping based on unknown properties.

As another example, the secondary analysis module 318 may provide indications identifying training data points that either lead to incorrect decisions, or have limited to no influence. An audit engine-derived, such as PNTK-derived, list of data points with minimal influence, such as data points of training data 308, may serve as a starting point for a dataset distillation procedure to minimize a size of the training dataset while still maintaining high neural network performance. The secondary analysis module 318 may also facilitate understanding of how the neural network 306 understands and relates data points. Such understanding may allow for a more advanced form of distillation where a set of ‘similar, nearby’ data points may be combined into fewer (or even one) ‘combined’ training point that captures the majority of the value of the original training data set. For example, metrics such as difficulty, impact, utility, and empirical utility may provide a way to sort model components by their effect on the training of the neural network or outputs of the neural network based on particular inputs. In particular, the secondary analysis module 318 may provide recommendations for extracting or may extract the highest value components or eliminate the lowest value components from training data 308 or neural network 306, distilling the components. For example, when using training dataset components, this operation may correspond to dataset distillation through removal of the least influential training data from the training dataset, or a subset of the training data that has a strongly negative utility, resulting in a smaller and cheaper dataset with similar or improved performance.

The secondary analysis module 318 may also determine one or more targeted counterfactuals. Specifically, the secondary analysis module 318 determine how the training data 308 or the audit data 310 could be modified in order promote accuracy, reduce uncertainty, or otherwise result in a specific outcome. Such determination may facilitate generation of an improved dataset and may also facilitate a deeper understanding of the neural network's decision making process or features used.

As another example, the secondary analysis module 318 provide dataset augmentation recommendations through artificial dataset augmentation or collection of more data. For example, given a proposed augmentation of a dataset, the secondary analysis module 318 may determine whether the new data is too similar to existing data, using an internal distance metric of a PNTK audit model of the neural network 306.

As another example, the secondary analysis module 318 may facilitate analysis, such as through use of the PNTK, of the selectivity and sensitivity of the neural network to various user-supplied features. Such analysis may be performed via either counterfactuals of data created by increasing or decreasing the feature within the data, or by using a PNTK to analyze feature-specific data groups. For example, given vectors of data associating features with datasets, such vectors may be analyzed against difficulty, impact, utility, and empirical utility. When a candidate is determined, the audit engine may explicitly analyze the PNTK using the candidate.

As another example, the secondary analysis module 318 may determine and generate indications of mislabeled data points in the training data 308. Mislabeled data points may, for example, have anomalous influences within the PNTK, which may be analyzed using anomaly detection techniques.

As another example, the secondary analysis module 318 may determine and generate indications of out of distribution (OOD) points. For example, points of data, such as points of data in training data 308, that are outside the training envelope, determined based on how much effort is required to fit a new data point in the neural network, may be detected through analysis of the neural network audit model 314, such as the PNTK. Such points of data may be referred to as OOD points. Such points may be located by the secondary analysis module 318 by fine tuning the audit engine 302 with the potential OOD point as the new audit, or input, data set without using the full audit engine. The audit engine 302 may, for example, integrate difficulty, as discussed herein, as a measure of total effort to learn the new point. As another example, fine-tuning may use the audit engine 302, in which case a full training process may not be necessary as the resulting partial audit engine outputs may be used to predict future learning and thus total difficulty and out of distribution status.

In some aspects, the audit output generation module 316 and the secondary analysis module 318 may be combined in a single module. The audit output generation module 316 and the secondary analysis module 318 may transmit indications of characteristics of the neural network 306 that impacted neural network outputs 312 corresponding to the audit data 310 to the client application 304. Such indications may allow a user of the client application 304 to examine the internal working of the neural network 306 and the training data 308 to determine how the neural network 306 generated particular outputs based on particular inputs.

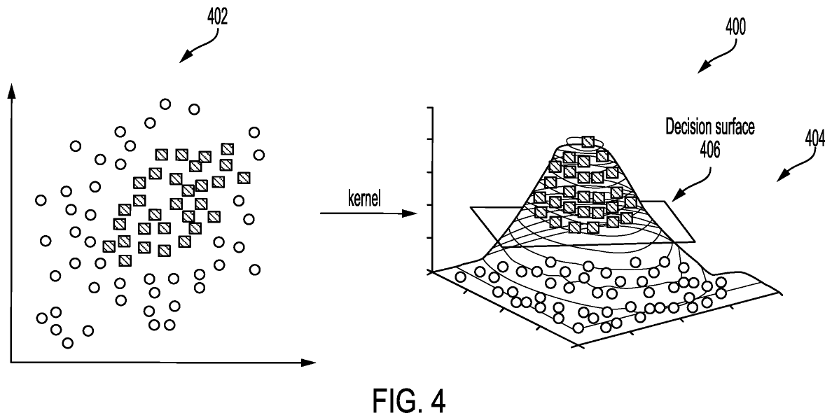

FIG. 4 is an example set 400 of graphs of an example NTK for a neural network generated by an audit engine as discussed herein. Graph 402 may be a two-dimensional graph of an example NTK, with squares representing neural network features that impact a particular output of the neural network and circles representing neural network features that do not impact, or have minimal impact on features the particular output of the neural network. Graph 404 may be a graph of the neural network across three axis, with squares similarly representing neural network features that impact a particular output of the neural network and circles similarly representing neural network features that do not impact, or have minimal impact on, features the particular output of the neural network. The decision surface 406 may divide features of the neural network that impact a particular output of the neural network from features of the neural network that do not impact, or have minimal impact on, the particular output of the neural network. An audit engine may identify features that correspond to the squares of graphs 402 and 404 for one or more test cases, or sets of input data, provided to the neural network.

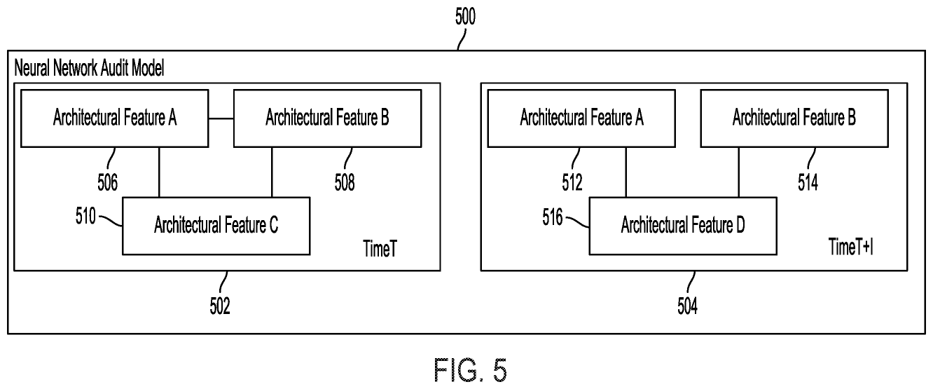

An example neural network audit model 500, such as a neural network audit model generated by an audit engine, is shown in FIG. 5. The neural network audit model 500 may be a PNTK, modeling the neural network as the neural network evolves over time. The neural network audit model 500 may be an audit trail or audit tensor. Thus, the neural network audit model 500 may be an audit model generated based on a machine learning or neural network model received and/or trained by the audit engine. The neural network audit model 500 may contain information regarding features of the neural network as the neural network is trained using training data. For example, the neural network may be trained over time using multiple sets of training data, or over multiple epochs. A first set 502 of features of the neural network at time T may include an architectural feature A 506, an architectural feature B 508, and an architectural feature C 510. Architectural features A 510, B 508, and C 510 may all be connected to each other. The audit engine may monitor training of a neural network and may update the audit model 500 as the neural network is trained. For example, a second set 504 of features of the neural network at time T+1 may include an architectural feature A 512, an architectural feature B 514, and an architectural feature C 516. Architectural features A 512 and B 514 may be connected to architectural feature D 516. Thus, over time, the architectural features of a neural network may change and connections between the architectural features may shift. Thus, an audit engine may be able to determine an impact that a time in training of a neural network at which input data, such as audit data, was input to the neural network had on one or more outputs of the neural network generated based on the input data.

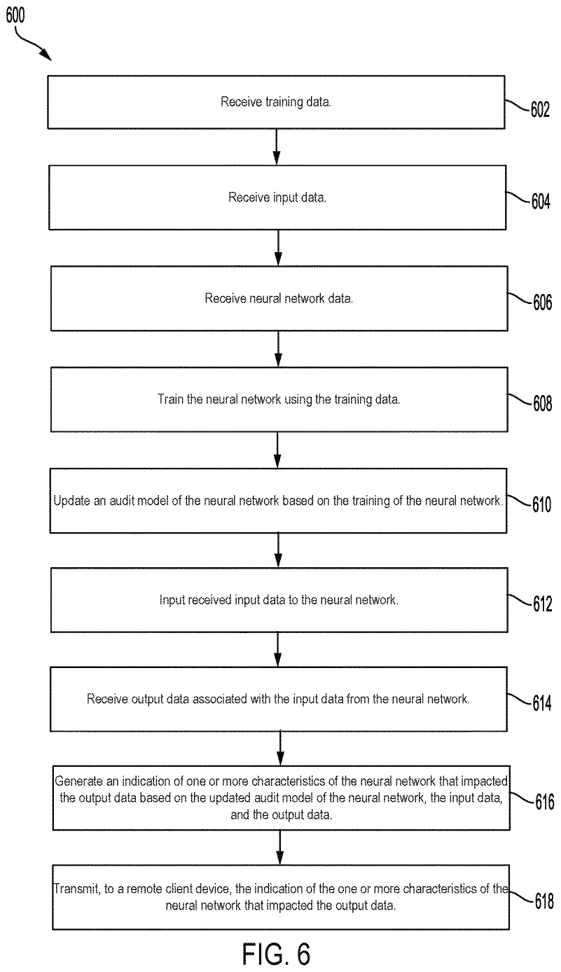

A computing device, such as a server or other computing device, may perform a method 600 for analysis of a neural network, as shown in FIG. 6. The method 600 may, for example, be performed in execution of a neural network audit engine. At block 602, the computing device may receive training data. For example, a computing device, such as a remote server or other computing device, may receive training data from a client computing device. The training data may, for example, include one or more sets of training data for one or more epochs of training of the neural network. In some aspects, the training data may include multiple data points with one or more associated categorization or classification parameters.

At block 604, the computing device may receive input data. The input data may also be referred to herein as audit data or test data. The input data may, for example, be received from a client computing device, such as the same client computing device from which the training data was received. The input data may, for example, include one or more test cases over which the audit engine should analyze performance of the neural network, to determine characteristics of the neural network that impact outputs generated by the neural network based on the test cases. In some aspects, an audit engine executed by the computing device may receive the input data. In some aspects, the input data may be the same as the training data, may include the training data, or may be a subset of the training data. Thus, receiving the input data and receiving the training data may, in some aspects, be performed in a same operation.

At block 606, the computing device may receive neural network data. For example, the computing device may receive one or more executable files, code, or other data for a neural network to be audited. In some aspects, the computing device may remotely monitor training of a neural network without receiving the neural network data. In some aspects, an audit engine executed by the computing device may receive the neural network data.

At block 608, the computing device may train the neural network using the training data. For example, the computing device may input training data to the neural network to train the neural network and may receive outputs from the neural network corresponding to training of the neural network. Training the neural network may include monitoring training of the neural network to determine characteristics of the neural network as the neural network is trained. For example, an audit engine executed by the computing device may provide the training data as input to the neural network and may monitor the neural network as the neural network is trained. In some aspects, training of the neural network may be performed by another computing device, and an audit engine of the computing device may monitor training of the neural network by the other computing device. Training of the neural network may include training the neural network over multiple epochs using multiple sets of training data.

At block 610, the computing device may update an audit model of the neural network based on the training of the neural network. For example, an audit engine executed by the computing device may update an audit model of the neural network based on the training of the neural network. In some aspects, updating the audit model of the neural network may be performed multiple times during training of the neural network, such as after each of multiple epochs of training of the neural network or at other times during training of the neural network. The audit model may, for example, be a PNTK model of the neural network, as discussed herein. In some aspects, the audit model of the neural network may be updated based on training data provided as input to the neural network and outputs received from the neural network based on the training data. For example, updating the audit model of the neural network may include updating an audit trail or audit tensor for the neural network.

At block 612, the computing device may input the received input data to the neural network, and at block 614 the computing device may receive output data from the neural network associated with the received input data. For example, the audit engine may provide one or more sets of input data for which performance of the neural network is to be analyzed to the neural network and may receive outputs of the neural network based on the one or more sets of input data to determine characteristics of the neural network that impacted the output data. In some aspects, the operations of blocks 610 and 612 may be performed multiple times during training of the neural network, to determine time-based characteristics of the neural network that may impact how the neural network processes the input data. In some aspects, the audit model of the neural network at block 610 may be updated based on the outputs of the neural network generated based on the input data.

At block 616, the computing device may generate an indication of one or more characteristics of a neural network that impacted the output data based on the updated audit model of the neural network, the input data, and the output data associated with the input data. For example, the audit engine may generate an indication of one or more characteristics of the neural network based on the input data, the output data, and the updated audit model of the neural network. In some aspects, the audit engine may generate indications of one or more characteristics of the neural network based on the updated audit model of the neural network, the input data, the training data, and output data generated by the neural network based on the training data and the input data. For example, the indication of the characteristics of the neural network may include an indication of one or more temporal aspects of the neural network that impacted the output data, an indication of one or more influence functions of the neural network, an indication of characteristic of the training data that impacted the output data, or an indication of one or more architectural components, such as one or more internal functions, of the neural network that impacted the output data. As another example, the indication of the characteristics of the neural network that impacted the output data may include an indication of a difficulty, an impact, or a utility of one or more components of the neural network, such as one or more internal functions of the neural network or one or more data elements of the training data used to train the neural network. As another example, the indication of one or more characteristics of the neural network may include one or more indications of features of the training data that impacted the output data generated by the neural network based on the input data. For example, the one or more features of the training data may include one or more outliers of the second set of input data. In some aspects, the computing device may remove such outliers from training data to generate a new training data set with the outliers removed, based on the indication of the one or more features of the training data that impacted the output data. As another example, the indication of one or more characteristics of the neural network may include one or more counterfactuals associated with the input data or the training data, one or more OOD inputs from the input data or the training data, an indication of a distilled version of the training data, or an indication of a distance between the training data and the input data. In some aspects, the one or more characteristics of the neural network may include one or more characteristics of input or training data, reduced or distilled training or input data sets, augmented training or input data sets, analysis of particular features of particular entries of a training or input data set or particular architectural components of the neural network, or indications of mis-labeled data elements in the training or input data set. In some aspects, generating an indication of one or more characteristics of a neural network that impacted output data may include performing secondary analysis on determined characteristics of the neural network to determine other characteristics of the neural network that impacted the output data.

At block 618, the neural network may transmit, to a remote client device, the indication of the one or more characteristics of the neural network that impacted the output data generated based on the input data. For example, the audit engine may transmit the findings of the audit engine regarding the features of the neural network that impact how the neural network analyzes the input data to a remote client device. Thus, an audit engine may audit a neural network by monitoring training of the neural network, modeling the neural network, such as by generating an audit trail or audit tensor for the neural network, and generating indications of characteristics of the neural network that impacted how the neural network generated particular outputs based on particular inputs and may provide analysis of the internal workings of the neural network to a remote client device. In some aspects, the audit engine may not transmit such indications to a remote client device.

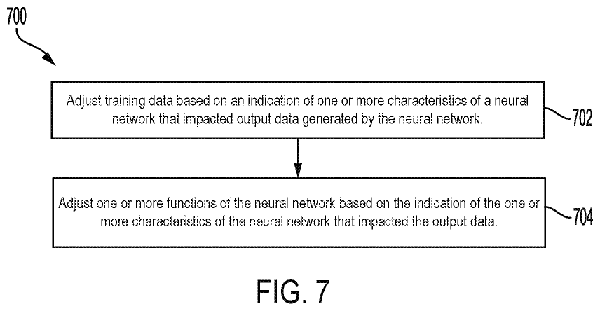

In some aspects, the audit engine may adjust one or more functions of an audited neural network, one or more data elements of training data, and/or one or more data elements of audit data based on determined characteristics of a neural network that impact outputs of the neural network generated based on particular inputs. A computing device, such as a server or other computing device, may perform a method 700 for adjusting a neural network and/or one or more data sets, as shown in FIG. 7. The computing device may, for example, perform the operations of the method 700 in combination with one or more blocks of the method 600. The computing device may, for example, perform the operations of the method 700 in execution of a neural network audit engine as described herein. At block 702, the computing device may adjust training data based on an indication of one or more characteristics of a neural network that impacted output data generated by the neural network. As one example, an audit engine executed by the computing device may adjust the training data received at block 602 of the method 600 based on the indication, generated at block 616 of the method 600, of the one or more characteristics of the neural network that impacted output data generated by the neural network based on the input data received at block 604 of the method 600. Adjusting the training data may, for example, include pruning the training data by removing one or more outliers or OOD data elements of the training data or one or more elements of the training data that had little impact on the operation of the neural network. As another example, adjusting the training data may include augmenting the training data set by adding one or more new data elements to the training data set.

At block 704, the computing device may adjust one or more functions of the neural network based on the indication of the one or more characteristics of the neural network that impacted the output data. As one example, an audit engine executed by the computing device may adjust the neural network data received at block 606 of the method 600 based on the indication, generated at block 616 of the method 600, of the one or more characteristics of the neural network that impacted output data generated by the neural network based on the input data received at block 604 of the method 600. For example, the computing device may adjust or remove one or more functions, such as architectural components, of the neural network to enhance efficiency and/or accuracy of the neural network based on the characteristics of the neural network. Thus, the audit engine may be used to prune or augment datasets or adjust architectural components of a neural network to enhance neural network training and operation.

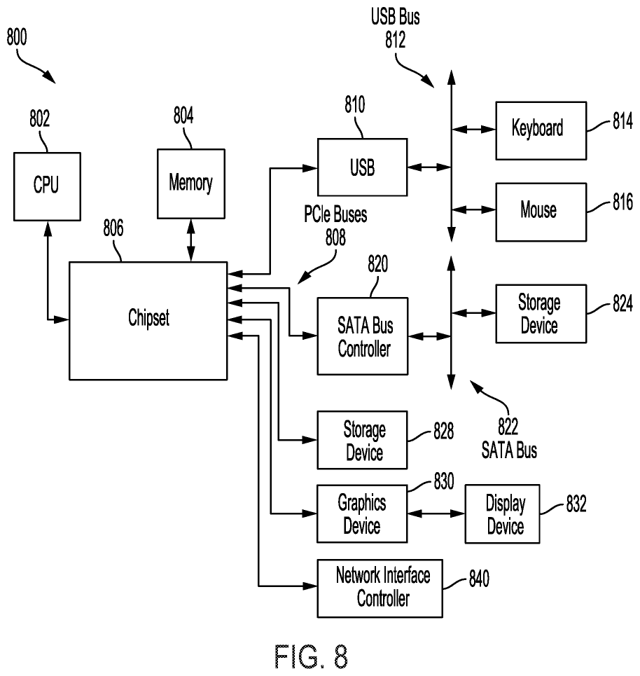

FIG. 8 is a block diagram of an example computing device 800 in which embodiments of the disclosure may be implemented. Computing device 800 may include a processor 802 (e.g., a central processing unit (CPU)), a memory (e.g., a dynamic random-access memory (DRAM)) 804, and a chipset 806. In some embodiments, one or more of the processor 802, the memory 804, and the chipset 806 may be included on a motherboard (also referred to as a mainboard), which is a printed circuit board (PCB) with embedded conductors organized as transmission lines between the processor 802, the memory 804, the chipset 806, and/or other components of the computer system. The components may be coupled to the motherboard through packaging connections such as a pin grid array (PGA), ball grid array (BGA), land grid array (LGA), surface-mount technology, and/or through-hole technology. In some embodiments, one or more of the processor 802, the memory 804, the chipset 806, and/or other components may be organized as a System on Chip (SoC).

The processor 802 may execute program code by accessing instructions loaded into memory 804 from a storage device, executing the instructions to operate on data also loaded into memory 804 from a storage device, and generate output data that is stored back into memory 804 or sent to another component. The processor 802 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 802 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 806 may facilitate the transfer of data between the processor 802, the memory 804, and other components. The chipset 806 may couple to other components through one or more PCIe buses 808.

Some components may be coupled to one or more bus lines of the PCIe buses 808. For example, components of the surgical robot 110 may be controlled through an interface coupled to the processor 802 through the PCIe buses 808. Another example component is a universal serial bus (USB) controller 810, which interfaces the chipset 806 to a USB bus 812. A USB bus 812 may couple input/output components such as a keyboard 814 and a mouse 816, but also other components such as USB flash drives, or another computer system. Another example component is a SATA bus controller 820, which couples the chipset 806 to a SATA bus 822. The SATA bus 822 may facilitate efficient transfer of data between the chipset 806 and components coupled to the chipset 806 and a storage device 824 (e.g., a hard disk drive (HDD) or solid-state disk drive (SDD)). The PCIe bus 808 may also couple the chipset 806 directly to a storage device 828 (e.g., a solid-state disk drive (SDD)). A further example of an example component is a graphics device 830 (e.g., a graphics processing unit (GPU)) for generating output to a display device 832, a network interface controller (NIC) 840 (which may provide wired or wireless access to a local area network (LAN) or a wide area network (WAN) device).

The schematic flow chart diagrams of FIGS. 6-7 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In one or more aspects, techniques for auditing neural network performance may include additional aspects, such as any single aspect or any combination of aspects described below or in connection with one or more other processes or devices described elsewhere herein. In a first aspect, an apparatus may be configured to perform operations comprising receiving a first set of input data for a neural network; training the neural network; updating an audit model of the neural network based on the training of the neural network; inputting, to the neural network, the first set of input data; receiving, from the neural network, a first set of output data associated with the first set of input data; and generating, based on the updated audit model of the neural network, the first set of input data, and the first set of output data, an indication of one or more characteristics of the neural network that impacted the first set of output data.

Additionally, the apparatus may perform or operate according to one or more aspects as described below. In some implementations, the apparatus includes one or more memories storing processor-readable code and one or more processors coupled to the one or more memories, the one or more processors configured to execute the processor-readable code to cause the one or more processors to perform operations described herein with respect to the apparatus. In some implementations, the apparatus includes a remote server, such as a cloud-based computing solution. In some other implementations, the apparatus may include a computer program product including a non-transitory computer-readable medium having instructions, such as program code, for causing one or more processors to perform operations described herein with reference to the apparatus. In some implementations, a method may include one or more operations described herein with reference to the apparatus.

In a second aspect, in combination with the first aspect, training the neural network includes inputting, to the neural network, a second set of input data; and receiving, from the neural network, a second set of output data associated with the second set of input data.

In a third aspect, in combination with one or more of the first aspect and the second aspect, updating the audit model of the neural network based on the training of the neural network and the first set of input data includes updating the audit model of the neural network based on the second set of input data and the second set of output data.

In a fourth aspect, in combination with one or more of the first aspect through the third aspect, the indication of the one or more characteristics includes an indication of one or more features of the second set of input data that impacted the first set of output data.

In a fifth aspect, in combination with one or more of the first aspect through the fourth aspect, the one or more features of the second set of input data that impacted the first set of output data include one or more outliers of the second set of input data, and the apparatus is further configured to perform operations including removing the one or more outliers from the second set of input data to generate a third set of input data based on the indication of the one or more features of the second set of input data that impacted the first set of output data.

In a sixth aspect, in combination with one or more of the first aspect through the fifth aspect, the indication of the one or more characteristics of the neural network includes at least one of: one or more counterfactuals associated with at least one of the first set of input data or the second set of input data; one or more out of distribution elements of the first set of input data or the second set of input data; an indication of a distilled version of the second set of input data; or an indication of a distance between the second set of input data and the first set of input data.

In a seventh aspect, in combination with one or more of the first aspect through the sixth aspect, the indication of the one or more characteristics of the neural network includes an indication of one or more temporal aspects of the neural network that impacted the first set of output data.

In an eighth aspect, in combination with one or more of the first aspect through the seventh aspect, the indication of the one or more characteristics of the neural network includes an indication of one or more influence functions of the neural network.

In a ninth aspect, in combination with one or more of the first aspect through the eighth aspect, the apparatus is further configured to perform operations comprising transmitting, to a remote client device, the indication of the one or more characteristics of the neural network that impacted the first set of output data.

In a tenth aspect, in combination with one or more of the first aspect through the ninth aspect, the audit model of the neural network comprises a path neural tangent kernel (PNTK) model of the neural network.

In an eleventh aspect, in combination with one or more of the first aspect through the tenth aspect, the indication of the one or more characteristics of the neural network that impacted the first set of output data includes an indication of at least one of: a difficulty, an impact, or a utility of at least one component of the neural network.

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naïve Bayes predictive modeling analysis of several varieties, learning vector quantization artificial neural network algorithms, or implementation of boosting algorithms such as adaptive boosting (AdaBoost) or stochastic gradient boosting systems for iteratively updating weighting to train a machine learning classifier to determine a relationship between an influencing attribute, such as received device data, and a system, such as an environment or particular user, and/or a degree to which such an influencing attribute affects the outcome of such a system or determination of environment.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for auditing neural network performance, comprising:
receiving a first set of input data for the neural network;
training the neural network;
updating an audit model of the neural network based on the training of the neural network;
inputting, to the neural network, the first set of input data;
receiving, from the neural network, a first set of output data associated with the first set of input data; and
generating, based on the updated audit model of the neural network, the first set of input data, and the first set of output data, an indication of one or more characteristics of the neural network that impacted the first set of output data.

2. The method of claim 1, wherein training the neural network comprises:
inputting, to the neural network, a second set of input data; and
receiving, from the neural network, a second set of output data associated with the second set of input data.

3. The method of claim 2, wherein updating the audit model of the neural network based on the training of the neural network and the first set of input data comprises:
updating the audit model of the neural network based on the second set of input data and the second set of output data.

4. The method of claim 2, wherein the indication of the one or more characteristics comprises an indication of one or more features of the second set of input data that impacted the first set of output data.

5. The method of claim 4, wherein the one or more features of the second set of input data that impacted the first set of output data comprise one or more outliers of the second set of input data, further comprising:
removing the one or more outliers from the second set of input data to generate a third set of input data based on the indication of the one or more features of the second set of input data that impacted the first set of output data.

6. The method of claim 2, wherein the indication of the one or more characteristics of the neural network comprises at least one of:
one or more counterfactuals associated with at least one of the first set of input data or the second set of input data;
one or more out of distribution elements of the first set of input data or the second set of input data;
an indication of a distilled version of the second set of input data; or
an indication of a distance between the second set of input data and the first set of input data.

7. The method of claim 1, wherein the indication of the one or more characteristics of the neural network comprises an indication of one or more temporal aspects of the neural network that impacted the first set of output data.

8. The method of claim 1, wherein the indication of the one or more characteristics of the neural network comprises an indication of one or more influence functions of the neural network.

9. The method of claim 1, further comprising:
transmitting, to a remote client device, the indication of the one or more characteristics of the neural network that impacted the first set of output data.

10. The method of claim 1, wherein the audit model of the neural network comprises a path neural tangent kernel (PNTK) model of the neural network.

11. The method of claim 1, wherein the indication of the one or more characteristics of the neural network that impacted the first set of output data comprises an indication of at least one of: a difficulty, an impact, or a utility of at least one component of the neural network.

12. An apparatus, comprising:
one or more memories storing processor-readable code; and
one or more processors coupled to the one or more memories, the one or more processors configured to execute the processor-readable code to cause the one or more processors to perform operations including:
receiving a first set of input data for a neural network;
training the neural network;
updating an audit model of the neural network based on the training of the neural network;
inputting, to the neural network, the first set of input data;
receiving, from the neural network, a first set of output data associated with the first set of input data; and
generating, based on the updated audit model of the neural network, the first set of input data, and the first set of output data, an indication of one or more characteristics of the neural network that impacted the first set of output data.

13. The apparatus of claim 12, wherein to train the neural network, the one or more processors are further configured to execute the processor-readable code to cause the one or more processors to perform operations including:
inputting, to the neural network, a second set of input data; and
receiving, from the neural network, a second set of output data associated with the second set of input data.

14. The apparatus of claim 13, wherein to update the audit model of the neural network based on the training of the neural network and the first set of input data, the one or more processors are further configured to execute the processor-readable code to cause the one or more processors to perform operations including:
updating the audit model of the neural network based on the second set of input data and the second set of output data.

15. The apparatus of claim 13, wherein the indication of the one or more characteristics of the neural network that impacted the first set of output data comprises an indication of one or more features of the second set of input data that impacted the first set of output data.

16. The apparatus of claim 15, wherein the one or more features of the second set of input data that impacted the first set of output data comprise one or more outliers of the second set of input data, and wherein the one or more processors are further configured to execute the processor-readable code to cause the one or more processors to perform operations including:
removing the one or more outliers from the second set of input data to generate a third set of input data based on the indication of the one or more features of the second set of input data that impacted the first set of output data.

17. A computer program product, comprising:
a non-transitory computer readable medium comprising instructions for causing one or more processors to perform operations comprising:
receiving a first set of input data for a neural network;
training the neural network;
updating an audit model of the neural network based on the training of the neural network;
inputting, to the neural network, the first set of input data;
receiving, from the neural network, a first set of output data associated with the first set of input data; and
generating, based on the updated audit model of the neural network, the first set of input data, and the first set of output data, an indication of one or more characteristics of the neural network that impacted the first set of output data.

18. The computer program product of claim 17, wherein to train the neural network, the non-transitory computer readable medium further comprises instructions for causing one or more processors to perform operations comprising:
inputting, to the neural network, a second set of input data; and
receiving, from the neural network, a second set of output data associated with the second set of input data.

19. The computer program product of claim 18, wherein the indication of the one or more characteristics of the neural network that impacted the first set of output data comprises an indication of one or more features of the second set of input data that impacted the first set of output data.

20. The computer program product of claim 19, wherein the one or more features of the second set of input data that impacted the first set of output data comprise one or more outliers of the second set of input data, and wherein the non-transitory computer readable medium further comprises instructions for causing one or more processors to perform operations comprising:
removing the one or more outliers from the second set of input data to generate a third set of input data based on the indication of the one or more features of the second set of input data that impacted the first set of output data.
